(19) United States
(12) Patent Application Publication
(10) Pub. No.: US 2009/0132589 A1
(43) Pub. Date: May 21, 2009

(54) SYSTEM AND METHOD FOR THRESHOLD-BASED NOTIFICATION OF DOCUMENT PROCESSING DEVICE STATUS

(76) Inventors: Brenda DAOS, Mission Viejo, CA (US); Marianne L. KODIMER, Huntington Beach, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/944,158

(22) Filed: Nov. 21, 2007

(51) Int. Cl. G06F 17/30

(52) U.S. Cl. 707/104.1; 707/E17.009

(57) ABSTRACT

The subject application is directed to a system and method for threshold-based notification of document processing device status. First, device status notifications are received from at least one document processing device. Next, threshold data corresponding to a preselected notification threshold is stored in an associated data storage. Count data, corresponding to the number of received device status notifications, is then stored in the associated data storage. A comparison is then made between the stored count data and the stored threshold data. A notification message is then generated to an associated administrator based upon the results of the comparison of threshold data and count data.

### BACKGROUND OF THE INVENTION

The subject application is directed generally to notification of system administrators as to the status of document processing devices. The system and method are more particularly suited to allowing an administrator to adjust notification parameters so as to minimize a number of unnecessary notices while still providing useful device feedback, particularly with more severe device concerns.

Document processing devices, such as printers, copiers, facsimile machines, and multifunction peripherals having more than one such function, are regularly subjected to status changes during use. By way of example, paper trays may be removed or changed, toner may need replacing, paper may run out, a jam may occur, or maintenance may need to be scheduled. Earlier systems have included a mechanism by which a notification, such as an electronic mail notification to an administrator, is completed after a status change, which may include an error signal, is recognized.

Many document processing device errors are not of particular interest to an administrator since the matter is readily resolvable by users, such as by adding paper. Other notifications may or may not be as severe, such as paper jams which end users are more capable of addressing. Other errors, such as when a device is out of toner or ink, may require an administrator to intervene given the complexity of a remedial operation.

Notification systems that generate administrator notices for any possibly relevant event can quickly overwhelm an administrator. This is particularly so in enterprises that have many document processing devices under administrative supervision. Merely generating notifications of more severe issues may result in failure to address situations that, while not individually severe, are indicative of cumulative errors and associated device concerns which may follow. By way of example, while a paper jam may not be of particular concern, if a device consistently suffers from paper jams, there may be an indication that a roller is worn, or that some other device in the paper processing mechanism is defective.

### SUMMARY OF THE INVENTION

In accordance with one embodiment of the subject application, there is provided a system and method for notification of system administrators as to status of document processing devices.

Further, in accordance with one embodiment of the subject application, there is provided a system and method suited to allowing an administrator to adjust notification parameters so as to minimize a number of unnecessary notices while still providing useful device feedback, particularly with more sever device concerns.

Still further, in accordance with one embodiment of the subject application, there is provided a system for threshold-based notification of document processing device status. The system comprises means adapted for receiving a plurality of device status notifications from at least one document processing device, a data storage adapted for storing threshold data corresponding to a preselected notification threshold, and an accumulator adapted for storing count data corresponding to a number of received device status notifications. The system also comprises comparison means adapted for comparing count data with threshold data and notification means adapted for generating a notification message to an associated administrator in accordance with an output of the comparison means.

In one embodiment of the subject application, the notification message includes data corresponding to an identity of the at least one document processing device and data corresponding to device status as indicated by received device status notifications. In a preferred embodiment, the device status includes an error notification generated by the at least one document processing device. In another preferred embodiment, the notification message further includes temporal data corresponding to a time when a threshold has been achieved in accordance with a determination of the comparison means.

In another embodiment of the subject application, the system also comprises means adapted for receiving re-notification data corresponding to generation of at least a second notification message and means adapted for generating at least a second notification message in accordance with received notification data.

In a further embodiment of the subject application, the system also comprises means adapted for storing severity level data corresponding to a severity level associated with device status notifications and means adapted for determining a severity level of received device status notifications in accordance with stored severity level data. In such embodiment, the notification means further includes means adapted for generating a notification message in accordance with a determined severity level.

Still further, in accordance with one embodiment of the subject application, there is provided a method for threshold-based notification of document processing device status in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for threshold-based notification of document processing device status according to one embodiment of the subject application;

FIG. 2 is a block diagram illustrating controller hardware for use in the system for threshold-based notification of document processing device status according to one embodiment of the subject application;

FIG. 3 is a functional diagram illustrating the controller for use in the system for threshold-based notification of document processing device status according to one embodiment of the subject application;

FIG. 4 is a block diagram illustrating administrative workstation hardware for use in the system for threshold-based notification of document processing device status according to one embodiment of the subject application;

FIG. 5 is a flowchart illustrating a method for threshold-based notification of document processing device status according to one embodiment of the subject application; and

FIG. 6 is a flowchart illustrating a method for threshold-based notification of document processing device status according to one embodiment of the subject application.

### DETAILED DESCRIPTION OF THE PREFERRED EMBODIMENT

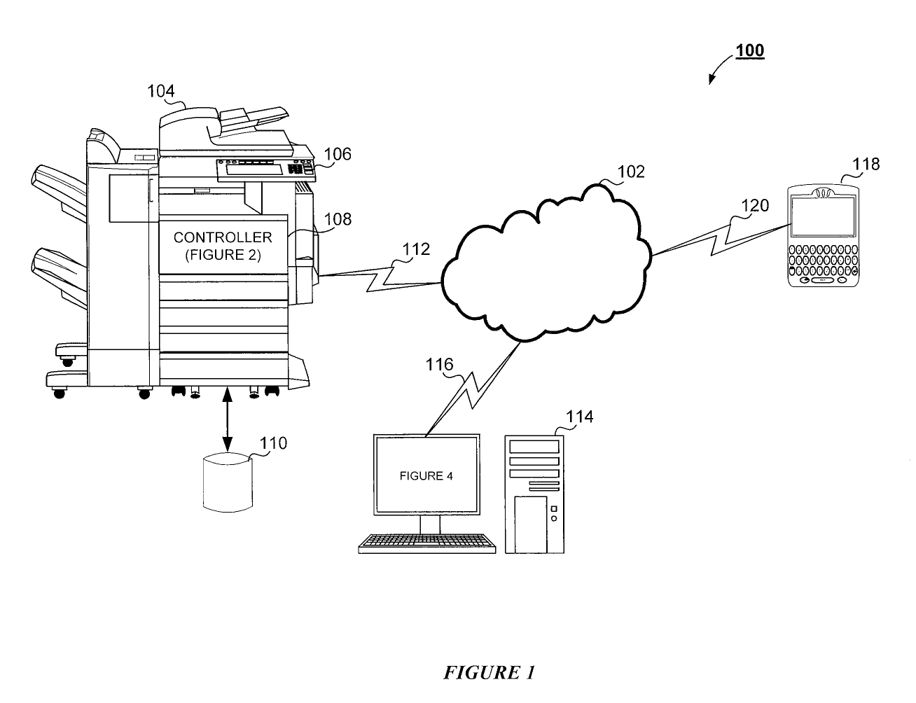

The subject application is directed to a system and method for threshold-based notification of document processing device status. In particular, the subject application is directed to a system and method for notification of system administrators as to status of document processing devices. More particularly, the subject application is directed to a system and method suited to allowing an administrator to adjust notification parameters so as to minimize a number of unnecessary notices while still providing useful device feedback, particularly with more severe device concerns. It will become apparent to those skilled in the art that the system and method described herein are suitably adapted to a plurality of varying electronic fields employing device management monitoring, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for threshold-based notification of document processing device status in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

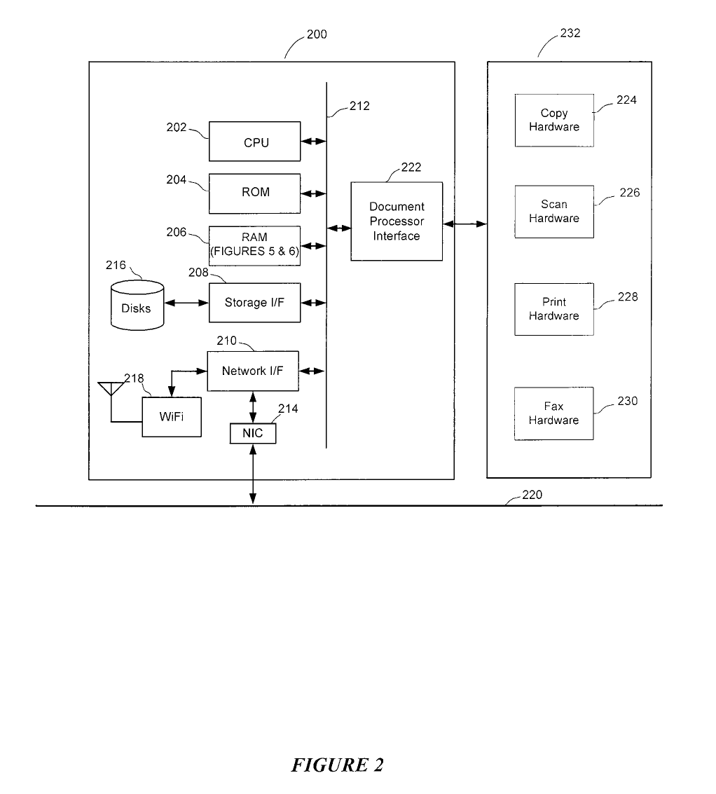

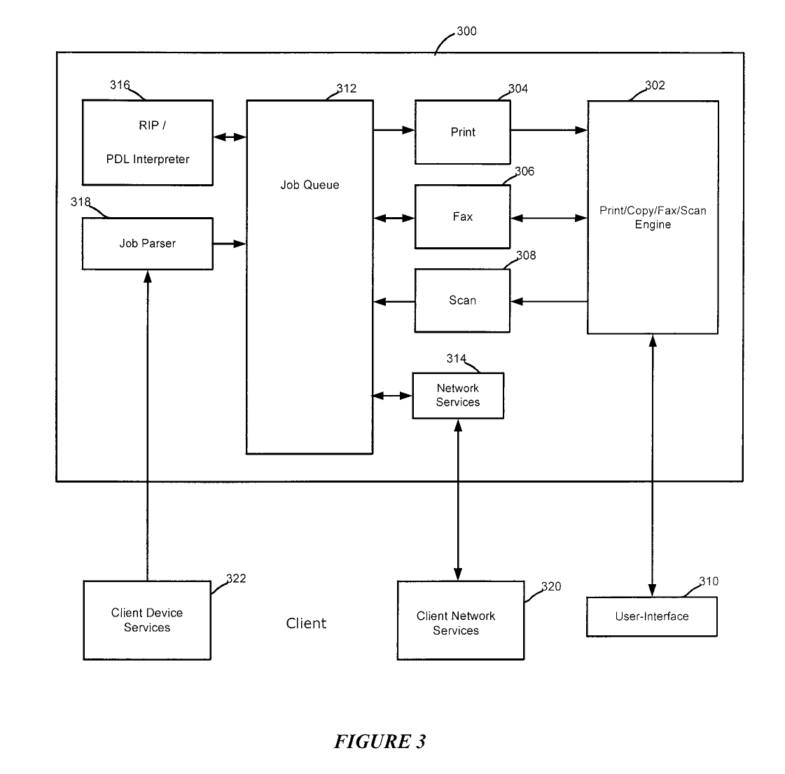

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for threshold-based notification of document processing device status of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

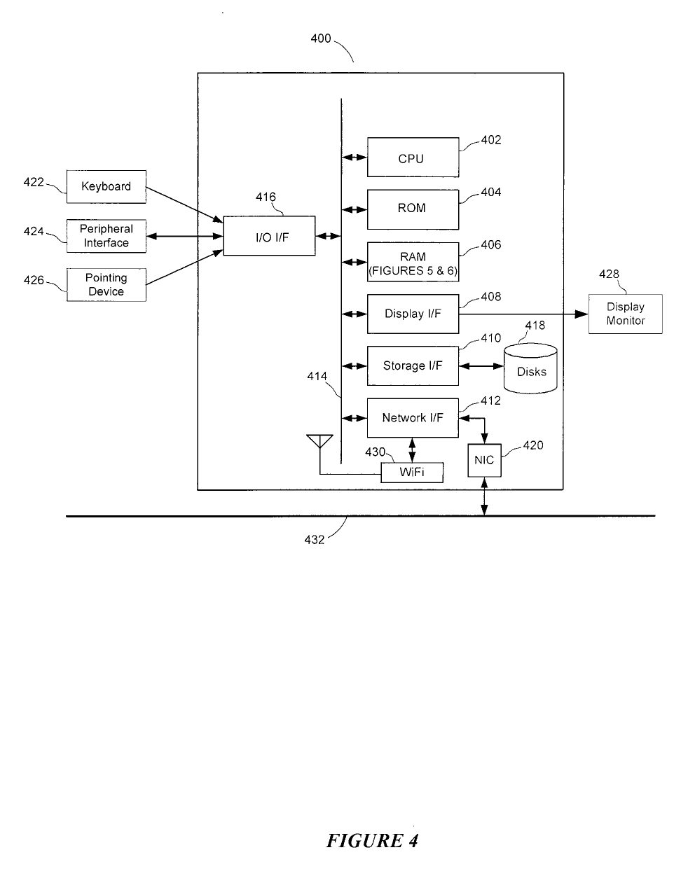

The system 100 illustrated in FIG. 1 further depicts an administrative device 114, in data communication with the computer network 102 via a communications link 116. It will be appreciated by those skilled in the art that the administrative device 114 is shown in FIG. 1 as a computer workstation for illustration purposes only. As will be understood by those skilled in the art, the administrative device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 114 is suitably adapted to generate and transmit document processing instructions, send and receive status alerts and device notifications, user interface modifications, upgrades, updates, personalization data, or the like, to the document processing device 104, or any other similar device coupled to the computer network 102. The functioning of the administrative device 114 will better be understood in conjunction with the block diagram illustrated in FIG. 4, explained in greater detail below.

The system 100 illustrated in FIG. 1 further depicts a portable device 118, in data communication with the computer network 102 via a communications link 120. It will be appreciated by those skilled in the art that the portable device 118 is shown in FIG. 1 as a smart phone for illustration purposes only. As will be understood by those skilled in the art, the portable device 118 is representative of any portable personal computing device known in the art, including, for example and without limitation, a laptop computer, a personal data assistant, a web-enabled cellular telephone, a proprietary network device, or other portable web-enabled electronic device. The communications link 120 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the portable device 118 is associated with an administrative user and is suitably adapted to network data, device status information, text messages, electronic mail messages, voice messages, alerts, or the like, via the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by the processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a job parser 318, which job parser suitably functions to receive print job language files from an external device, such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

Turning now to FIG. 4, illustrated is a hardware diagram of a suitable workstation 400, illustrated in FIG. 1 as the administrative device 114, for use in connection with the subject system. A suitable administrative device 114, e.g. the workstation 400 of FIG. 4, includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, a plurality of device status notifications are first received from at least one document processing device. Threshold data corresponding to a preselected notification threshold is then stored and count data corresponding to a number of received device status notifications is then stored. The stored count data is then compared with the threshold data. Based upon the results of the comparison, a notification message is generated to an associated administrator.

In accordance with one example embodiment of the subject application, a device management component is initiated by the controller 108 or other suitable component associated with the document processing device 104 so as to monitor the status of the associated document processing device 104. Preferably, the controller 108, via such a component, monitors the operations of the document processing device 104 with respect to consumables, device errors where the device still remains functional, paper jams, communication errors, device errors where the device is inoperable, and the like. The skilled artisan will appreciate that other errors, events, or occurrences are capable of being monitored in accordance with this example embodiment of the subject application. It will be appreciated by those skilled in the art that while reference is made herein to a single document processing device 104, the subject application is capable of implementation with a plurality of devices, such that multiple devices are monitored in accordance with the methodology set forth herein.

The controller 108 or other suitable component associated with the document processing device 104 continues to monitor the status of the device 104 until a device status notification is received. It will be appreciated by those skilled in the art that such notification includes, for example and without limitation, a detection of an error, a hardware malfunction, paper jam, toner low, paper out, software impairment, and the like. Following the receipt of a notification, the controller 108 or other suitable component associated with the document processing device 104 first determines the severity level associated with the notification. For example, a warning level would correspond to a typical user-correctable error, e.g. low toner, paper out, or the like, whereas a critical level would correspond to an administrative or service-provider correctable error, e.g. paper jam, communication error, hardware failure, or the like.

Once the severity level associated with the received device status notification has been determined, stored severity level data is retrieved by the controller 108 from the associated data storage device 110 corresponding to a predetermined severity level. The severity level determined from the device status notification is then compared to the predetermined severity level to determine whether the determined severity level meets or exceeds the predetermined severity level. That is, a determination is made whether or not the severity associated with the device status notification is a critical error or an error correctable by a typical user.

When the severity level matches the predetermined severity level retrieved from the associated data storage device 110, the controller 108 or other suitable component associated with the document processing device 104 generates a notification message corresponding to the received device status notification. In accordance with one embodiment of the subject application, the notification message includes, for example and without limitation, type of error, count data, date/time stamp of error detection, short description of the error, customer contact data, device identification data, system identification data, network address data, number of previous notifications sent, if any, or the like.

The controller 108 or other suitable component associated with the document processing device 104 then retrieves, from the associated data storage 110, notification instructions associated with the notification of the administrator of the device status. In accordance with one embodiment of the subject application, the notification instructions include, for example and without limitation, notification threshold, notification recipient (administrator, service provider, technician, etc.), notification type (electronic mail, phone, none, text message, user-interface display, etc.), re-notification threshold, re-notification recipient, re-notification type, and the like. The notification message is then communicated to the designated recipient, e.g., the administrator, in accordance with the retrieved notification instructions. For example, when the notification instructions indicate an electronic mail communication, the message is communicated to the electronic mail address associated with the administrator, e.g. received via the portable data device 118 or the administrative device 116. In another example, when the notification instructions indicate voice notification, the message is communicated as a voice message to the portable data device 118, e.g. a voicemail message, a telephone call, or the like.

Following communication of the notification message, the controller 108 or other suitable component associated with the document processing device 104 determines whether or not the device status has been rectified, e.g. whether the error prompting the notification message has been corrected. It will be understood by those skilled in the art that the controller 108 or other suitable component associated with the document processing device 104, while awaiting the rectification of the error continues to monitor the device status as set forth above. In the event that the error giving rise to the device status notification has not been rectified within a predetermined period of time, i.e. a duration set by an administrator, a new notification message (second, third, etc.) is generated by the controller 108 or other suitable component associated with the document processing device 104 inclusive of the details of the previous notification message(s). The new notification message is then communicated to the recipient designated in the notification instructions, e.g. the administrative device 114, the portable data device 118, or the like.

When the severity level determined from the received device status notification does not meet the predetermined severity level, count data is retrieved from the data storage device 110 corresponding to the number of received device status notifications. In accordance with one embodiment of the subject application, the count data corresponds to a duration of an error, e.g. out of paper for an amount of time, a frequency of an error, e.g. device functions, but one non-critical service repeatedly fails, or the like. The retrieved count data is then incremented accordingly in response to the received device status notification, e.g. the duration of the error is extended, the number of errors over time is increased, or the like. The controller 108 or other suitable component associated with the document processing device 104 then retrieves stored threshold data from the associated data storage 110 corresponding to a preselected threshold, e.g. maximum duration of a given error, maximum allowable frequency of an error, or the like. Preferably, the preselected threshold is suitably set by an associated administrator, service-provider, or other authorized party. The count data is then compared to the threshold data to determine whether or not a notification message is to be sent to the administrator. In the event that the threshold has not yet been exceeded, the controller 108 or other suitable component associated with the document processing device 104 returns to monitoring the status of the document processing device 104.

When the threshold has been exceeded as a result of the received device status notification, a notification message is generated by the controller 108 or other suitable component associated with the document processing device 104 as set forth in greater detail above. Notification instructions associated with the received device status notification are then retrieved from the associated data storage device 110 and the generated notification message is communicated to the associated recipient as designated by the notification instructions. Operations continue thereafter with the resending of the notification message as needed to correct the error associated with the received device status notification. Following rectification of the event or error giving rise to the device status notification, the controller 108 or other suitable component associated with the document processing device 104 continues with the monitoring of the document processing device 104 as set forth in greater detail above.

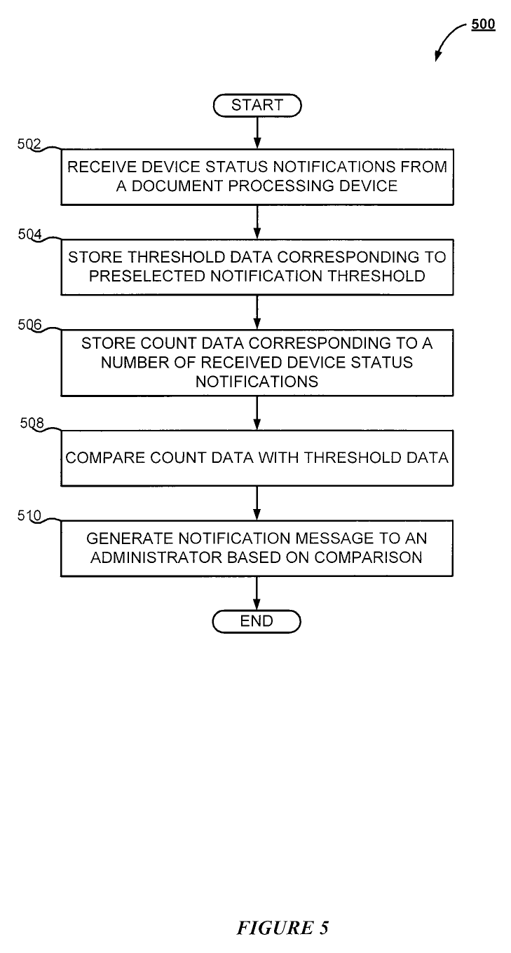

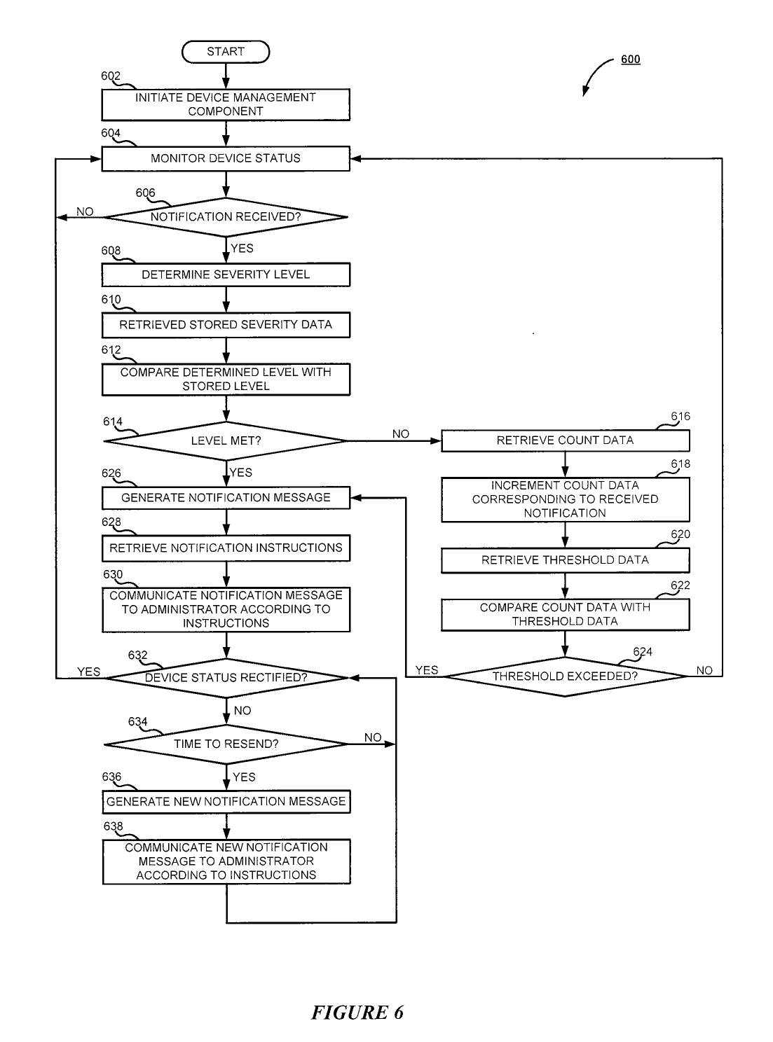

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for threshold-based notification of document processing device status in accordance with one embodiment of the subject application. Beginning at step 502, a plurality of device status notifications are received from at least one document processing device, e.g. the document processing device 104 as shown in FIG. 1. In accordance with one embodiment of the subject application, the received device status notifications correspond to events, errors, or the like associated with the functioning and operations of the associated document processing device 104. It will be understood by those skilled in the art that device status notifications are capable of being received from a plurality of document processing devices and the description of a single document processing device 104 is for example purposes only.

At step 504, the controller 108 or other suitable component associated with the document processing device 104 stores threshold data corresponding to a preselected notification threshold in the associated data storage device 110. It will be appreciated by those skilled in the art that the notification threshold includes, for example and without limitation, a duration of an event, a frequency of an event, or the like. Count data is then stored on the associated data storage device 110 at step 506 corresponding to a number of received device status notifications. The controller 108 or other suitable component associated with the document processing device 104 then compares, at step 508, the stored count data and the stored threshold data. At step 510, the controller 108 or other suitable component associated with the document processing device 104 generates a notification message to an associated administrator in accordance with the results of the comparison of threshold data and count data.

Referring now to FIG. 6, there is shown a flowchart 600 illustrating a method for threshold-based notification of document processing device status in accordance with one embodiment of the subject application. The methodology depicted in FIG. 6 begins at step 602, whereupon the controller 108 or other suitable component associated with the document processing device 104 initiates a device management component, as will be understood by those skilled in the art. In accordance with one embodiment of the subject application, a plurality of document processing devices initiate a device management component, thereby monitoring the functions and operations of the associated document processing device. Reference is made herein with respect to FIG. 6 to a single document processing device (e.g. the document processing device 104 of FIG. 1) monitoring and notifying in accordance with the subject application for example purposes only. The controller 108 or other suitable component associated with the document processing device 104 then monitors device status, e.g. the functions and operations of the document processing device 104, at step 604. According to one example embodiment of the subject application, the controller 108 or other suitable component associated with the document processing device 104 monitors the operations of the document processing device 104 with respect to consumables, device errors where the device still remains functional, paper jams, communication errors, device errors where the device is inoperable, and the like. It will be understood by those skilled in the art that other errors, events, or occurrences are capable of being monitored in accordance with this example embodiment of the subject application.

A determination is then made at step 606 whether a device status notification has been received by the controller 108 or other suitable component associated with the document processing device 104. A negative determination at step 606 prompts flow to return to step 604, whereupon the controller 108 or other suitable component continues the monitoring of the status of the device 104 until a device status notification is received. Upon a determination at step 606 that a device status notification has been received, flow proceeds to step 608, whereupon the severity level associated with the received device status notification message is determined. In accordance with one embodiment of the subject application, the device status notification includes, for example and without limitation, a detection of an error, a hardware malfunction, paper jam, toner low, paper out, software impairment, and the like. For example, a notification having a warning severity level would correspond to a typical user-correctable error, e.g. low toner, paper out, or the like, whereas a device status notification having a critical severity level would correspond to an administrative or service-provider correctable error, e.g. paper jam, communication error, hardware failure, or the like.

Following the determination of the severity level associated with the received device status notification, stored severity level data, corresponding to a predetermined severity level, is retrieved by the controller 108 from the associated data storage device 110 at step 610. At step 612, the determined severity level associated with the device status notification is compared to the predetermined severity level. A determination is then made at step 614 whether the predetermined severity level has been met, i.e. matched, by the severity level determined from the received device status notification.

Upon a determination at step 614 that the severity level determined from the received device status notification does not meet the predetermined severity level, flow proceeds to step 616. At step 616, the controller 108 or other suitable component associated with the document processing device 104 retrieves count data from the data storage device 110 corresponding to the number of received device status notifications. Preferably, the stored count data corresponds to a duration of an error, e.g. out of paper for an amount of time, a frequency of an error, e.g. device functions, but one non-critical service repeatedly fails, or the like. After retrieval, the controller 108 or other suitable component associated with the document processing device 104 increments the count data in response to the received device status notification at step 618. For example, the increment of the count data corresponds to the extension of the duration of the error, an increase in the number of errors over time, or the like. At step 620, threshold data stored in the associated data storage device 110 corresponding to a predetermined threshold, e.g. maximum duration of a given error, maximum allowable frequency of an error, or the like, is retrieved. In accordance with one embodiment of the subject application, the predetermined threshold is determined by an associated administrator, service-provider, or other authorized party. The incremented count data is then compared at step 622 to the threshold data. A determination is then made at step 624 whether a notification message is to be sent to the administrator. When it is determined that the threshold has not yet been exceeded, flow returns to step 604, whereupon the controller 108 or other suitable component associated with the document processing device 104 continues to monitor the status of the document processing device 104.

Upon a determination at step 624 that the threshold has been exceeded as a result of the received device status notification, flow proceeds to step 626. At step 626, the controller 108 or other suitable component associated with the document processing device 104 generates a notification message. It will be appreciated by those skilled in the art that the notification message includes, for example and without limitation, type of error, count data, date/time stamp of error detection, short description of the error, customer contact data, device identification data, system identification data, network address data, number of previous notifications sent, if any, or the like. Notification instructions are then retrieved from the associated data storage 110 at step 628 by the controller 108 or other suitable component associated with the document processing device 104 corresponding to the notification of the device status to the administrator. According to one particular embodiment of the subject application, the notification instructions include, for example and without limitation, notification threshold, notification recipient (administrator, service provider, technician, etc.), notification type (electronic mail, phone, none, text message, user-interface display, etc.), re-notification threshold, re-notification recipient, re-notification type, and the like. At step 630, the controller 108 or other suitable component associated with the document processing device 104 communicates the notification message to the designated recipient in accordance with the retrieved notification instructions. For example, when the notification instructions indicate an electronic mail communications, the message is communicated to the electronic mail address associated with the administrator, e.g. received via the portable data device 118 or the administrative device 116. In another example, when the notification instructions indicate voice notification, the message is communicated as a voice message to the portable data device 118, e.g. a voicemail message, a telephone call, or the like.

A determination is then made at step 632, whether the error giving rise to the device status notification has been rectified. The skilled artisan will appreciate that the controller 108 or other suitable component associated with the document processing device 104, while awaiting the rectification of the error continues to monitor the device status as set forth above. Upon a determination at step 632 that the error giving rise to the device status notification has not been rectified, flow proceeds to step 634. At step 634, a determination is made whether a predetermined period of time has lapsed, e.g. a duration set by an administrator. Upon a determination that it is not time to resend the notification message, flow returns to step 632 to determine whether the error has been rectified. When it is determined at step 634 that the predetermined period of time has lapsed, thereby warranting a new notification message, flow proceeds to step 636. At step 636, a new notification message, for example a second message or the like, is generated by the controller 108 or other suitable component associated with the document processing device 104 inclusive of the details of the previous notification message(s). The controller 108 or other suitable component associated with the document processing device 104 then communicates the new notification message to the recipient designated in the notification instructions at step 638, e.g. the administrative device 114, the portable data device 118, or the like. Thereafter, operations return to the monitoring of the device status at step 604.

Returning to step 614, when it is determined that the severity level determined from the received device status notification matches the predetermined severity level retrieved from the associated data storage device 110, flow progresses to step 626. At step 626, the controller 108 or other suitable component associated with the document processing device 104 generates a notification message corresponding to the received device status notification. At step 628, notification instructions are retrieved from the data storage device 110 by the controller 108 or other suitable component associated with the document processing device 104. The generated notification message is then communicated to the designated recipient at step 630 in accordance with the retrieved notification instructions. Flow then proceeds to step 632, whereupon a determination is made whether the error prompting the device status notification has been corrected. Upon a determination that the error has been rectified, operations return to monitoring the document processing device 104 at step 604, as set forth in greater detail above.

When it is determined at step 632 that the error giving rise to the device status notification has not yet been corrected, flow proceeds to step 634, whereupon a determination is made whether a predetermined period of time has expired, i.e. whether it is lime to resend the notification message to the administrator. Upon the expiration of such time, flow proceeds to step 636, whereupon a new notification message, e.g. a second notification message, is generated inclusive of the details referenced above with respect to the first notification message, as well as an indication as to the number of previous notification messages sent. The new notification message is then communicated, at step 638, to the recipient(s) designated by the notification instructions. Thereafter, flow returns to step 604, whereupon the operations of the document processing device 104 are monitored as set forth above.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for threshold-based notification of document processing device status comprising:
means adapted for receiving a plurality of device status notifications from at least one document processing device;
a data storage adapted for storing threshold data corresponding to a preselected notification threshold;
an accumulator adapted for storing count data corresponding to a number of received device status notifications;
comparison means adapted for comparing count data with threshold data; and
notification means adapted for generating a notification message to an associated administrator in accordance with an output of the comparison means.

2. The system of claim 1 wherein the notification message includes data corresponding to an identity of the at least one document processing device and data corresponding to device status as indicated by received device status notifications.

3. The system of claim 2 wherein the device status includes an error notification generated by the at least one document processing device.

4. The system of claim 2 wherein the notification message further includes temporal data corresponding to a time when a threshold has been achieved in accordance with a determination of the comparison means.

5. The system of claim 1 further comprising:
means adapted for receiving re-notification data corresponding to generation of at least a second notification message; and
means adapted for generating at least a second notification message in accordance with received notification data.

6. The system of claim 1 further comprising:
means adapted for storing severity level data corresponding to a severity level associated with device status notifications;
means adapted for determining a severity level of received device status notifications in accordance with stored severity level data; and
wherein the notification means further includes means adapted for generating a notification message in accordance with a determined severity level.

7. A method for threshold-based notification of document processing device status comprising the steps of:
receiving a plurality of device status notifications from at least one document processing device;
storing threshold data corresponding to a preselected notification threshold;
storing count data corresponding to a number of received device status notifications;
comparing count data with threshold data; and
generating a notification message to an associated administrator in accordance with an output of the comparison step.

8. The method of claim 7 wherein the notification message includes data corresponding to an identity of the at least one document processing device and data corresponding to device status as indicated by received device status notifications.

9. The method of claim 8 wherein the device status includes an error notification generated by the at least one document processing device.

10. The method of claim 8 wherein the notification message further includes temporal data corresponding to a time when a threshold has been achieved in accordance with a determination of the comparison step.

11. The method of claim 7 further comprising the steps of:
receiving re-notification data corresponding to generation of at least a second notification message; and
generating at least a second notification message in accordance with received notification data.

12. The method of claim 1 further comprising the steps of:
storing severity level data corresponding to a severity level associated with device status notifications;
determining a severity level of received device status notifications in accordance with stored severity level data; and
generating a notification message in accordance with a determined severity level.
